(19) United States
(12) Patent Application Publication
(10) Pub. No.: US 2024/0097204 A1
(43) Pub. Date: Mar. 21, 2024

(54) ELECTROLYTE FOR METAL-AIR BATTERY

(71) Applicants: HOCHSCHULE ANHALT, Köthen (DE); MARTIN-LUTHER-UNIVERSITÄT HALLE-WITTENBERG, Halle (Saale) (DE)

(72) Inventors: Richard SCHALINSKI, Halle (Saale) (DE); Ralf Boris WEHRSPOHN, Halle (Saale) (DE)

(73) Assignees: HOCHSCHULE ANHALT, Köthen (DE); MARTIN-LUTHER-UNIVERSITÄT HALLE-WITTENBERG, Halle (Saale) (DE)

(21) Appl. No.: 18/240,821

(22) Filed: Aug. 31, 2023

(30) Foreign Application Priority Data
Sep. 8, 2022 (DE) 102022122814.2

(51) Int. Cl. H01M 10/26; H01M 4/24; H01M 4/38; H01M 12/08

(52) U.S. Cl. CPC H01M 10/26; H01M 4/24; H01M 4/386; H01M 12/08; H01M 2300/0014

(57) ABSTRACT

The present invention relates to an electrolyte for use in metal-air batteries comprising at least one polyalkylene glycol containing ethylene oxide or propylene oxide units or mixtures thereof in an alkaline solution. Further, the invention relates to a metal-air battery comprising an anode, a cathode and an ion-conducting electrolyte interposed therebetween, wherein the anode contains a metal selected from the group of aluminum (Al), iron (Fe), lithium (Li), zinc (Zn), magnesium (Mg) or silicon (Si) and the cathode is an air electrode and the electrolyte comprises at least one polyalkylene glycol containing ethylene oxide or propylene oxide units or mixtures thereof in an alkaline solution.

The invention relates to an electrolyte for metal-air batteries and to a battery system containing the electrolyte.

### STATE OF THE ART

With the global interest in electrochemical energy storage for powering hybrid, plug-in hybrid, or electric vehicles (EVs), development has focused on the miniaturization of lightweight, rechargeable batteries. Lithium (Li)-ion batteries with high energy efficiency and a high number of charge cycles have become the most promising candidates for EV applications. However, their low storage capacity, safety issues, and high cost are disadvantages. Alternative energy storage systems represent metal-air battery systems, such as Li-air, Mg-air, Zn-air, Al-air, and Si-air batteries, which can be used in the future for the power supply of automobiles, industrial equipment, computers, electronic devices, and a variety of consumer products.

An electric battery is an interconnection of several similar galvanic cells or elements. Strictly speaking, the term “battery” refers only to non-rechargeable, so-called “primary cells” or “primary elements”. In contrast, rechargeable “secondary cells” or “secondary elements” are referred to as rechargeable batteries”. The term “battery has been softened somewhat recently, however, so that in the context of this invention the term “battery” will also be used in the following for rechargeable energy storage devices in a generalized manner.

Metal-air batteries usually have a plurality of interconnected electrochemical cells, wherein the cells are constructed in layers and comprise a positive electrode and a negative electrode, a separator and an electrolyte. The electrolyte can be liquid or gel-like, or it can be a solid electrolyte. The electrolyte serves in particular to ensure ion transport between the two electrodes. In particular, the separator has the task of preventing contact between the two oppositely polarized electrodes and ensuring ion flow. A metal, for example metallic silicon, is used as the negative electrode. Instead of requiring a second reagent within the cell, metal-air batteries react with atmospheric oxygen. Air electrodes, i.e. oxygen (O₂) based electrodes, are usually used as the positive electrode. The oxygen is supplied by the ambient air and drawn into the cell body of the metal-air battery as required. This makes a metal-air battery lighter and more compact to manufacture than a lithium-ion battery.

Metal-air batteries not only have a high energy density (400-1700 Wh kg⁻¹), but are also compact, inexpensive, lightweight and environmentally friendly. The reason for the high energy density of metal-air batteries is their cathode, which uses oxygen present in the air during discharge, replacing expensive chemicals used in current Li-ion batteries. Silicon (Si) air batteries, in particular, are seen as a promising alternative to conventional storage media because they are cheaper, more environmentally friendly and less sensitive to external agents. The Si-air battery has a comparable specific energy density to the lithium air battery. In addition, silicon (28.2%) is more abundant in the earth's crust compared to lithium (0.002%) and is also less expensive than lithium metal.

One problem with metal-air batteries is their severely limited cycle stability, which is due in particular to the consumption of the electrolyte by side reactions. Cycle stability refers to the number of times a battery can be discharged and then recharged until its capacity falls below a certain value. Charging and discharging a metal-air battery also causes the metal to be attacked, with the metal-air battery or the respective cells of the metal-air battery being contaminated by degradation products and products from the side reactions, resulting in significant capacity losses of the metal-air battery after only one cycle of charging and discharging. Thus, however, the rechargeability and short runtime of metal-air batteries remains a challenging task.

Silicon air batteries operated with alkaline electrolytes exhibit the problem of limited discharge capacity, which means that the electrochemical reactions stop before the entire anode is consumed. While a main advantage of using an alkaline solution as an electrolyte is that Si(OH)₄ is dissolved, there is also the problem that strong side reactions occur when using such electrolytes, leading to self-discharge of the cell. In addition, significant corrosion reactions occur in Si-air batteries with alkaline electrolytes, as well as reduced anode efficiency during discharge. The corrosion reaction and the electrochemical half-cell reactions for the discharge process can be described as follows:

Anode: Si+4 OH⁻⇄Si(OH)₄+4 e⁻ (1)

Cathode: O₂+2H₂O+4 e⁻⇄4 OH⁻ (2)

Corrosion: Si+2 OH⁻+2 H₂O→SiO₂(OH)₂²⁻+2H₂ (3)

As a measure of the proportion of side reactions, the conversion efficiency η is introduced as a parameter, which is the electrochemically converted mass of silicon divided by the total consumed mass of silicon:

$$η ( \% ) = \overline{Mloss , total} \times 100 ,$$

where M_{loss,total} is the experimentally determined anode mass loss during cell operation and M_{loss,corrosion} is the mass loss corresponding to the corrosion reaction (Eq. (3)). The corrosion mass values of the Si anodes are calculated by subtracting the electrochemically discharged mass (Eq. (1)) from the total mass loss of the Si wafers. The difference M_{loss; total}−M_{loss,corrosion} gives the total silicon mass consumed in the anodic reaction and can be calculated directly from the practical discharge capacity.

A primary Si-air battery using nanostructured silicon as anode material and an electrolyte based on an alkaline solution was investigated by Zhong et al [Zhong et al. ChemSusChem 5, 177-180 (2012)]. However, the structures used there are etched away within a few minutes to hours due to the strong side reactions and are thus not suitable for continuous discharges.

Durmus et al. describe a system in which the alkaline electrolyte is pumped through the cell, thus providing a large reservoir [Durmus et al., Electrochim. Acta, 225, 215-224 (2017)]. Conditioned by the large reservoir, the concentration of silicates could be kept low here, thus preventing surface passivation. It was possible to discharge with 50 μA cm⁻² for 1100 h, achieving conversion efficienciesη of 3%.

WO 2010/100636 A1 and WO 2011/061728 A1 disclose Si-air batteries containing an anode of amorphous silicon or silicon single crystal wafers, which may be doped with antimony (Sb), phosphorus (P), arsenic (Ar), boron (B), aluminum (Al) or gallium (Ga). The air cathode contains carbon and, for example, magnesium as catalyst on a nickel grid. Aqueous alkaline solutions containing silica and fluoride or alternatively ionic liquids (RTIL) such as EMI.2.3HF.F are used as electrolytes.

In the DE 10 2013 114 767 A1 publication, a battery is disclosed which has an electrode comprising a microstabilized, at least partially porous silicon-based semiconductor layer, in particular a doped microcrystalline silicon layer. The electrolyte used is an alkaline electrolyte such as KOH solution.

The conversion efficiency η for discharge over near-application periods for alkaline silicon air batteries has so far been only 3%. In addition, there is a rapid passivation of the surface, which prevents the complete discharge of the existing silicon.

Against this background, it is an object of the present invention to provide an alkaline electrolyte for use in metal-air batteries which reduces the proportion of side reactions and thus makes it possible to provide a metal-air battery, in particular a silicon air battery, which can store larger quantities of electrical energy at low cost and has sufficient capacity or energy. In particular, it should have a high conversion efficiency and low parasitic losses and thus be characterized by a long lifetime.

### DISCLOSURE OF THE INVENTION

To solve this problem, an electrolyte for use in metal-air batteries is proposed comprising at least one polyalkylene glycol containing ethylene oxide or propylene oxide units or mixtures thereof in an alkaline solution. Also an object of the present invention is a metal-air battery comprising an anode, a cathode and an ion-conducting electrolyte interposed therebetween, wherein the anode contains a metal selected from the group of aluminum (Al), iron (Fe), lithium (Li), zinc (Zn), magnesium (Mg) or silicon (Si) and the cathode is an air electrode and the electrolyte according to the invention comprises at least one polyalkylene glycol containing ethylene oxide or propylene oxide units or mixtures thereof in an alkaline solution.

The anode of the metal-air battery contains a material selected from the group of aluminum (Al), iron (Fe), lithium (Li), zinc (Zn), magnesium (Mg) or silicon (Si), preferably Si.

In a preferred embodiment, the anode contains amorphous silicon or is in the form of a single crystal wafer, and it is particularly preferred to use it as a silicon crystal wafer.

Single crystal wafers are characterized by a specific crystal orientation. Since silicon has a cubic diamond structure, the surface is oriented in one of several relative directions when cut into wafers. These are known as crystal orientations and are defined by the Miller index, with [100], [111] or [101] surfaces being the most common in silicon. In accordance with the present invention, the orientation of the silicon crystal may be, for example, the [100], the [111], or the [101] crystal orientation, preferably the [100] and the [111] crystal orientation, particularly preferably the [100] crystal orientation.

The silicon crystal wafers used as anode may contain a p-type and/or n-type dopant. Suitable examples include antimony (Sb), phosphorus (P) and arsenic (As) as donor (n-type) dopants and boron (B), aluminum (Al) and gallium (Ga) as acceptor (p-type) dopants. Preferred dopants are dopants selected from the group of As, Sb, P, and B, and phosphorus (P) is particularly preferred as a dopant. The dopant can be of n-type, n⁺-type or n⁺⁺-type or of p-type, p⁺-type or p⁺⁺-type.

In one embodiment, the anode is a silicon crystal wafer that is n-doped with phosphorus (P).

To improve the electrical properties of the silicon anode, one or more metals may be incorporated therein. For example, the anode may be made of a metal alloy with silicon having 1 to 99 weight percent of at least one metal. The metal(s) can be any metal, including alkali metals, alkaline earth metals, transition metals such as lithium (Li), sodium (Na), magnesium (Mg), copper (Cu), nickel (Ni), zinc (Zn), aluminum (Al), germanium (Ge), gallium (Ga), silver (Ag), and manganese (Mn).

The surface of the silicon can also be present in modified form, for example, as semiconductor nanowires or nanorods. In this case, the semiconductor nanowires are grown from the surface under suitable growth conditions, or the semiconductor substrates are patterned with masking materials and then etched in various ways to obtain vertically aligned nanostructures. Also known for the fabrication of semiconductor nanowires is MAC etching (“metal-assisted chemical etch”), in which a thin metal seed layer (usually a noble metal such as Ag, Au) is first deposited on the Si surface, and then the seed-covered Si material is subjected to electroless etching in a mixture of oxidant and etchant.

The silicon can also be in the form of a powder. The anodic silicon powder may have a particle size in the range of 0.1 micrometer to 1 millimeter. The anodic powder may also be formed from an alloy of silicon and other metals (a powder of the alloy) or be a mixture of silicon powder and powder of one or more other metals.

The electrolyte to be used in air-metal batteries according to the invention contains an alkaline solution.

Suitable aqueous alkaline solutions may contain hydroxides of alkali metals such as lithium (LiOH), sodium (NaOH) or potassium (KOH). In a preferred embodiment of the invention, an aqueous KOH solution is used as the electrolyte. The aqueous alkaline solutions can be used in a concentration range from 0.01 mol/l to 8 mol/l, preferably from 0.5 mol/l to 8 mol/l, more preferably from 0.75 mol/l to 5 mol/l, most preferably from 0.5 mol/l to 2 mol/l.

According to one embodiment, an aqueous KOH solution is used in a concentration of 2 mol/l. According to a preferred embodiment, an aqueous KOH solution is used in a concentration of 0.5 mol/l.

The electrolyte to be used in air-metal batteries according to the invention contains at least one polyalkylene glycol containing ethylene oxide or propylene oxide units or mixtures thereof. Suitable polyalkylene glycols are, for example, polyalkylene glycols end-group-capped on one or both sides with alkyl, carboxyl or amino groups. Polyethylene glycol, polypropylene glycol and block copolymers of ethylene oxide and propylene oxide or mixtures thereof are preferred. The block copolymers may contain ethylene oxide and propylene oxide polymerized in any amounts and in any order. The OH end groups of the polyalkylene glycols may optionally be capped with a methyl group.

In a preferred embodiment of the invention, polyethylene glycol or polypropylene glycol is used, and polyethylene glycol is particularly preferred. In a particularly preferred embodiment, PEG 400 with an average molecular weight of 380 to 420 g/mol is used.

The polyalkylene glycol can be used in a concentration of 100 μmol/l to 1.5 mol/l. In a preferred embodiment of the invention, polyethylene glycol is used in a concentration of 0.1 mol/l to 1.0 mol/l.

According to a preferred embodiment, the electrolyte to be used in air-metal batteries according to the invention contains an aqueous KOH solution at a concentration of 0.5 mol/l and polyethylene glycol at a concentration of 1.0 mol/l.

It has been shown that the presence of at least one polyalkylene glycol, preferably polyethylene glycol, significantly increases the conversion efficiency η without limiting the maximum current density or prematurely passivating the silicon surface. This also allows the use of larger surface areas and thus higher currents, which increase performance.

Fluoride anions and/or fluoride releasing molecules can also be added to the electrolyte. Examples of suitable fluoride anion source molecules include HF, NH₄F and KF.

The air electrode of the battery of the invention may be in the form of a plate, a fiber material, a mesh, a rod, a tubular body, a sintered-type cathode (having a sintered-type body), or a foam-type cathode (having a foamed body).

The air electrode contains at least one electrically conductive material. The electrically conductive material is not subject to any particular restrictions, provided that it has electrical conductivity. Examples include a carbon-containing material, a perovskite-type electrically conductive material, an electrically conductive porous polymer, or a metal body.

The carbonaceous material may be a porous or non-porous carbonaceous material. Preferably, the carbonaceous material is a porous carbonaceous material. This is because it has a large specific surface area and can provide many reaction sites. A concrete example of the porous carbonaceous material is mesoporous carbon. Concrete examples of the non-porous carbonaceous material include graphite, acetylene soot, carbon soot, carbon nanotubes, and carbon fibers.

In one embodiment, the air electrode has a porous layer of carbon.

The electrically conductive metal body may be made of a known metal material that is resistant to the electrolyte. The metal body may be a body on the surface of which a metal layer (coating film) is applied or consists entirely of metal material. The metal layer or metal material contains at least one metal selected from the group consisting of nickel (Ni), chromium (Cr) and aluminum (Al). The shape of the metal body may be a known shape such as a metal grid, a perforated metal foil, or a foam metal.

The air electrode may contain a catalyst that promotes electrode reactions. The catalyst may be at least partially deposited as a layer on the electrically conductive material.

Suitable catalysts are those that have oxygen reduction capability and can be used in metal-air batteries. Examples are ruthenium (Ru), rhodium (Rh), palladium (Pd) or platinum (Pt) or alloys such as Pt alloys (e.g. with gold (Au); PtAu), which can be used as electrocatalysts for the oxygen reduction reaction. Also suitable as catalysts are high spin transition metal complexes with spinel and perovskite morphology, such as the oxides of the transition metals manganese (Mn), cobalt (Co), iron (Fe), and nickel (Ni). Another class of catalysts are the inorganic-organic composites such as FeCo-EDA or Ni/Fe with polyoxometalate (POM) and o-anisidine (oA) or metal-coordinated organic compounds with a porphyrin or phthalocyanine structure. Furthermore, an inorganic ceramic such as manganese dioxide (MnO₂) or cerium dioxide (CeO₂) can be used as a catalyst. Also suitable as catalysts are graphene or carbonaceous materials as well as nanotechnologically produced metal composites with heterocyclic conjugated polymers (polyaniline, polypyrrole and poly(3,4-ethylenedioxythiophene).

Another class of suitable catalysts for the gas electrode are carbon nanomaterials doped with heteroatoms such as N and S, such as vertically aligned nitrogen-doped carbon nanotubes (VA-NCNT) or graphene-based B/N-co-doped carbon nanosheets (G-CBP).

In a preferred embodiment, the air electrode has manganese dioxide (MnO₂) as a catalyst.

In some embodiments, an additional layer of highly porous material may also be provided over the catalyst layer. Such an additional layer may further facilitate and promote oxygen dissociation at the cathode. The porous layer may include a carbonaceous substance or a non-carbonaceous mineral or a polymeric substance, such as a fluorinated ethylene-propylene polymer.

The air electrode can contain a binder to fix the electrically conductive material. Suitable binders include e.g. polyvinylidene fluoride (PVdF), polytetrafluoroethylene (PTFE) and styrene-butadiene rubber (SBR).

If required, the metal-air battery of the present invention comprises the separator for isolating the air electrode from the anode. A suitable separator preferably has a porous structure. Mention may be made, for example, of a grid structure in which constituent fibers are arranged regularly, a nonwoven structure in which constituent fibers are arranged randomly, and a three-dimensional mesh structure which has separate holes and connected holes. Specific examples of separators include porous films made of polyethylene, polypropylene, polyethylene terephthalate, or cellulose, and nonwovens such as a resin nonwoven or a glass fiber nonwoven.

Further advantageous details, features and design details of the invention are explained in more detail in connection with the embodiment examples shown in the FIGURES and are not limiting for these. Herein:

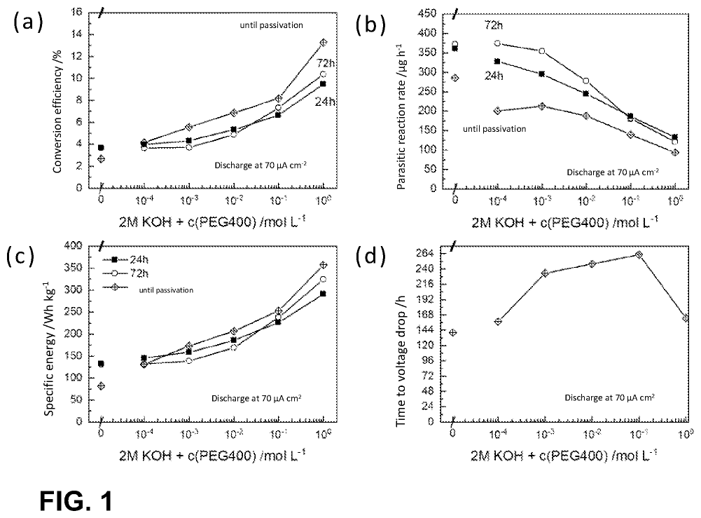

FIG. 1 is a schematic representation of the discharge experiments in 2 M KOH with varying concentration of PEG 400 at a current density of 70 μA/cm² over 24 h (—▪—), 72 h (—◯—) and until [symbol] passivation ( [symbol] ) (Example 1). Here, FIG. 1 shows the parasitic corrosion rate in FIG. a), the conversion efficiency in FIG. b), the specific energy in FIG. c) and the time period to voltage drop in FIG. d).

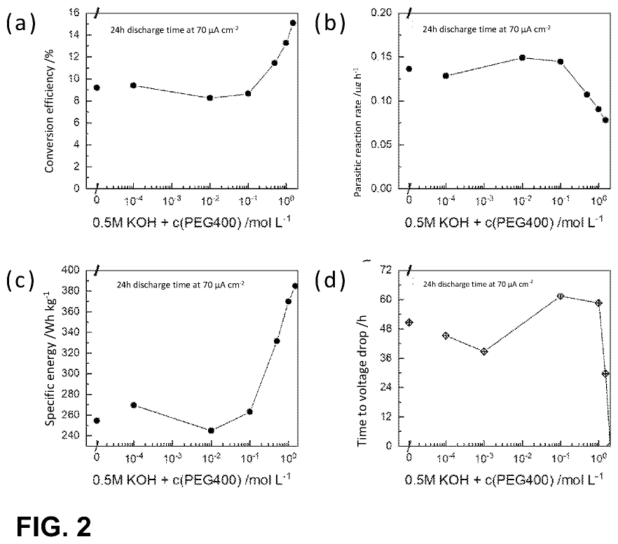

FIG. 2 is a schematic representation of the discharge experiments in 0.5 M KOH with varying concentration of PEG 400 at a current density of 70 μA/cm² over 24 h (—●—) in FIGS. a), b), c) and in FIG. d) until the time point of voltage drop ( [symbol] ) (passivation) (example 2). Here, FIG. a) represents the parasitic corrosion rate, FIG. b) the conversion efficiency, FIG. c) the specific energy, and FIG. d) the time period to voltage drop.

### EXAMPLE 1

In the present Example 1, the parasitic corrosion rate, conversion efficiency, specific energy, and time period to voltage drop were measured as a function of the concentration of polyethylene glycol in a 2 M KOH solution as electrolyte.

In Example 1, polyethylene glycol (PEG 400) with an average molecular weight of 380 to 420 g/mol was used. Concentrations of 100 μmol/l to 1.5 mol/l PEG 400 were mixed with 0.5 to 8 mol/l KOH and then used as electrolyte in test cells with phosphorus doped n-type silicon with a smooth [100] surface as anode and an air electrode consisting of nickel braid with MnO₂ catalyst in a carbon matrix and PTFE membrane on the cathode side.

In FIG. 1, (a) the conversion efficiency η in %, (b) the parasitic reaction rate in mg/h, (c) the specific energy in Wh/kg, and (d) the discharge time to voltage drop (passivation) in h are shown, where respectively the parameters were measured for a PEG 400 concentration of 0, 10⁻⁴, 10⁻³, 10⁻², 10⁻¹ und 1 mol/l in a potassium hydroxide solution with a concentration of 2 mol/l.

The conversion efficiency η, parasitic corrosion rate and specific energy were measured for a duration of 24 h (—▪—), 72 h (—◯—) and until passivation ( [symbol] ).

It can be clearly seen that the conversion efficiency η increases at a concentration of PEG 400 of 10⁻³ to 1 mol/l for the measurement at 24 h as well as 72 h up to about 10% and is over 13% when measured up to passivation (FIG. 1, FIG. a)). This shows a clear increase in conversion efficiency η with increasing PEG 400 content, although the discharge time to passivation is not affected.

The time to voltage drop ( [symbol] ) is greater than or equal to 230 h for a concentration of PEG 400 from 10⁻³ to 10⁻¹ mol/l (FIG. 1, FIG. d)).

The parasitic corrosion rate also decreases significantly at a concentration of PEG 400 from 10⁻³ to 1 mol/l.

### EXAMPLE 2

In the present Example 2, the parasitic corrosion rate, conversion efficiency, specific energy, and time period to voltage drop were measured as a function of the concentration of polyethylene glycol in a 0.5 M KOH solution as electrolyte.

In Example 2, polyethylene glycol (PEG 400) with an average molecular weight of 380 to 420 g/mol was used. Solutions with concentrations of 100 μmol/l to 2 mol/l PEG 400 and 0.5 mol/l KOH were prepared and then used as electrolyte in test cells with phosphorus-doped n-type silicon with a smooth [100] surface as anode and an air electrode consisting of nickel braid with MnO₂ catalyst in a carbon matrix and PTFE membrane on the cathode side.

In FIG. 2, a) the conversion efficiency η in %, b) the parasitic reaction rate in mg/h, c) the specific energy in mWh/g, and d) the discharge time to voltage drop (passivation) in h are given, where respectively the parameters were measured for a PEG 400 concentration of 0, 10⁻⁴, 10⁻², 10⁻¹, 0.5, 1, and 1.5 mol/l in a potassium hydroxide solution with a concentration of 0.5 mol/l.

The conversion efficiency η, the parasitic corrosion rate and the specific energy were measured for a duration of 24 h (—●—) and until passivation ( [symbol] ).

It can be clearly seen that the conversion efficiency η increases up to 13.2% at a concentration of PEG 400 from 10⁻² to 1 mol/l for the measurement over 24 h and is 15% at a concentration of 1.5 mol/l (FIG. 2, FIG. a)).

Thereby, a significant increase of the conversion efficiency η with increasing PEG 400 content is shown, wherein the possible discharge time until passivation is even prolonged at concentrations of 0.1 to 1 mol/l.

With increasing concentration of PEG 400, the parasitic reaction rate decreases significantly from 149 to 78 μg/h at 0.01 and 1.5 mol/l, respectively, corresponding to a 48% reduction (FIG. 2, FIG. b)).

The time to voltage drop ( [symbol] ) is over 58 h for a concentration of PEG 400 from 10⁻¹ to 1 mol/l, while higher concentrations lead to earlier passivation (FIG. 2, FIG. d)).

Thus, an optimal concentration in terms of discharge time and conversion efficiency is 1 mol/l PEG 400 with 0.5 mol/l KOH at over 13% for 58 h at 70 μA/cm⁻².

1. The electrolyte for use in metal-air batteries, wherein the electrolyte comprises at least one polyalkylene glycol containing ethylene oxide or propylene oxide units or mixtures thereof in an alkaline solution.

2. The electrolyte according to claim 1, wherein the alkaline solution contains potassium hydroxide (KOH).

3. The electrolyte according to claim 2, wherein the potassium hydroxide is present in a concentration of 0.01 mol/1 to 8 mol/l.

4. The electrolyte according to claim 1, wherein the electrolyte contains polyethylene glycol.

5. The electrolyte according to claim 1, wherein the electrolyte contains polyethylene glycol in a concentration of 100 μmol/1 to 1.5 mol/l.

6. The electrolyte according to claim 2, wherein the electrolyte contains polyethylene glycol in a concentration of 0.1 mol/1 to 1.0 mol/l.

7. A metal-air battery comprising an anode, a cathode and an ion-conducting electrolyte interposed therebetween, wherein the anode contains a metal selected from the group of aluminum (Al), iron (Fe), lithium (Li), zinc (Zn), magnesium (Mg) or silicon (Si) and the cathode is an air electrode and an electrolyte comprises at least one polyalkylene glycol containing ethylene oxide or propylene oxide units or mixtures thereof in an alkaline solution.

8. The metal-air battery according to claim 7, wherein the anode contains silicon (Si).

9. The metal-air battery according to claim 8, wherein the anode contains amorphous silicon or is in the form of a silicon wafer.

10. The metal-air battery according to claim 8, wherein the silicon is in the form of a powder.
